(19) United States
(12) Patent Application Publication
(10) Pub. No.: US 2025/0239033 A1
(43) Pub. Date: Jul. 24, 2025

(54) REAL-TIME 3D AR OBJECT ACQUISITION DEVICE, SYSTEM, AND METHOD

(71) Applicant: KOREA ELECTRONICS TECHNOLOGY INSTITUTE, Seongnam-si, Gyeonggi-do (KR)

(72) Inventors: Junhwan JANG, Paju-si (KR); Woochool PARK, Incheon (KR); Minsu CHOI, Seoul (KR); Junsuk LEE, Seoul (KR)

(21) Appl. No.: 19/089,407

(22) Filed: Mar. 25, 2025

Related U.S. Application Data
(63) Continuation of application No. PCT/KR2022/017597, filed on Nov. 10, 2022.

(30) Foreign Application Priority Data
Oct. 12, 2022 (KR) 10-2022-0130976

(51) Int. Cl. G06T 19/00; G06T 3/40

(52) U.S. Cl. CPC G06T 19/006; G06T 3/40

(57) ABSTRACT

Proposed are a real-time three-dimensional (3D) augmented reality (AR) object acquisition device, system, and method that makes it possible to acquire a high-resolution 3D AR object in real time. The system may include an image acquisition device for acquiring a plurality of images required to create a 3D AR object of a subject in real time, and a 3D AR object acquisition device for acquiring a high-resolution 3D AR object in real time on the basis of the plurality of images. The 3D AR object acquisition device may include a 3D AR object creation module that uses the plurality of images to create the 3D AR object in real time, and an upscale module that upscales the resolution of each frame of an image of the created 3D AR object by a factor of n to convert the 3D AR object into a high-resolution 3D AR object in real time.

### CROSS REFERENCE TO RELATED APPLICATIONS

This is a continuation application of International Patent Application No. PCT/KR2022/017597 filed on Nov. 10, 2022, which claims priority to Korean patent application No. 10-2022-0130976 filed on Oct. 12, 2022, contents of each of which are incorporated herein by reference in their entireties.

### BACKGROUND

### Technical Field

The present disclosure relates to a 3D AR object image acquisition technology, and more particularly, to a real-time 3D AR object acquisition device, system, and method that support the acquisition of a high-resolution 3D AR object in real time.

### Description of Related Technology

Since the advent of virtual reality (VR) and augmented reality (AR), mixed reality (MR) is being utilized in various fields such as education, games, exhibition halls, and industry as interest in various smartphone applications has increased.

### SUMMARY

One aspect is a real-time 3D AR object acquisition device, system, and method that support acquiring a high-resolution 3D AR object in real time.

Another aspect is a real-time 3D AR object acquisition system that includes an image acquisition device acquiring a plurality of images required for creating a 3D AR object of a subject in real time; and a 3D AR object acquisition device acquiring a high-resolution 3D AR object in real time based on the plurality of images.

The 3D AR object acquisition device includes a 3D AR object creation module that creates the 3D AR object in real time by using the plurality of images; and an upscale module that upscales a resolution of each frame of an image of the created 3D AR object by a factor of n to convert the 3D AR object into a high-resolution 3D AR object in real time.

The image acquisition device may include an RGB camera, a depth camera, a LiDAR sensor, and a radar sensor.

The 3D AR object creation module may include an object data extraction unit that extracts data for a specific object selected from each of the plurality of images; a 3D AR object creation unit that merges the extracted object data to create the 3D AR object; and a 3D AR object verification unit that verifies the created 3D AR object.

The 3D AR object acquisition device may further include an interface that connects the image acquisition device and the 3D AR object acquisition device.

The interface may support a connection of the image acquisition device and the 3D AR object creation module, control driving of the image acquisition device, check a connection status of the image acquisition device and an on-off status of the image acquisition device, and provide error information occurring in a physical connection or setting value setup of the image acquisition device.

The 3D AR object creation module may transmit the image of the created 3D AR object to the upscale module in units of single frame.

The upscale module may upscale each frame to a real-time processible multiple of resolution.

The upscale module may upscale each frame to a maximum real-time processible multiple of resolution.

Another aspect is a real-time 3D AR object acquisition device including a 3D AR object creation module that creates a 3D AR object in real time by using a plurality of images received from an image acquisition device that acquires the plurality of images required for creating the 3D AR object of a subject in real time; and an upscale module that upscales a resolution of each frame of an image of the created 3D AR object by a factor of n to convert the 3D AR object into a high-resolution 3D AR object in real time.

Another aspect is a real-time 3D AR object acquisition method including, by a real-time 3D AR object acquisition device, receiving a plurality of images from an image acquisition device that acquires the plurality of images required for creating a 3D AR object of a subject in real time; by the real-time 3D AR object acquisition device, creating the 3D AR object in real time by using the plurality of images; and by the real-time 3D AR object acquisition device, converting the 3D AR object into a high-resolution 3D AR object in real time by upscaling a resolution of each frame of an image of the created 3D AR object by a factor of n.

According to the present disclosure, the 3D AR object acquisition device can provide a high-resolution 3D AR object in real time by creating a 3D AR object in real time using images acquired through the image acquisition device and upscaling the resolution of each frame of an image of the created 3D AR object by a factor of n through the upscale module.

### BRIEF DESCRIPTION OF THE DRAWINGS

FIG. 1 is a diagram showing a real-time 3D AR object acquisition system according to an embodiment of the present disclosure.

FIG. 2 is a diagram showing an interface of the 3D AR object acquisition device of FIG. 1.

FIG. 3 is a diagram showing a 3D AR object creation module of the 3D AR object acquisition device of FIG. 1.

FIG. 4 is a diagram showing the 3D AR object creation unit of FIG. 3.

FIG. 5 is a diagram showing an upscale module of the 3D AR object acquisition device of FIG. 1.

FIG. 6 is a flowchart showing a real-time 3D AR object acquisition method according to an embodiment of the present disclosure.

### DETAILED DESCRIPTION

In the case of AR, augmented images are processed based on images captured by a camera, so the amount of data to be processed is very large. This leads to a problem in that AR contents are not widely used because high-spec hardware devices are required to implement AR-based contents or AR contents must be implemented in very limited environments.

Because the amount of data processing for AR contents is large, there is a problem in that the real-time nature of content applied to AR is low.

Additionally, in the case of AR contents generated in real time, there is a problem in that the image quality is relatively low compared to the full HD (FHD) or ultra HD (UHD) image quality that is currently widely used in real life.

In the following description, only parts necessary to understand embodiments of the present disclosure will be described, and other parts will not be described to avoid obscuring the subject matter of the present disclosure.

Terms used herein should not be construed as being limited to their usual or dictionary meanings. In view of the fact that the inventor can appropriately define the meanings of terms in order to describe his/her own invention in the best way, the terms should be interpreted as meanings consistent with the technical idea of the present disclosure. In addition, the following description and corresponding drawings merely relate to specific embodiments of the present disclosure and do not represent all the subject matter of the present disclosure. Therefore, it will be understood that there are various equivalents and modifications of the disclosed embodiments at the time of the present application.

Now, an embodiment of the present disclosure will be described in detail with reference to the accompanying drawings.

### Real-Time 3D AR Object Acquisition System

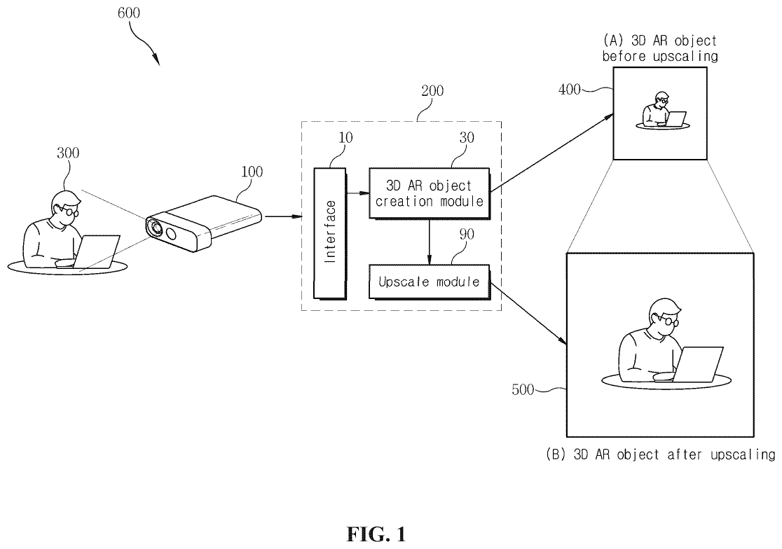

FIG. 1 is a diagram showing a real-time 3D AR object acquisition system according to an embodiment of the present disclosure.

Referring to FIG. 1, the real-time 3D AR object acquisition system 600 according to this embodiment is a system that creates a 3D AR object 400 using an image acquired for a subject 300 in real time, and then acquires a high-resolution 3D AR object 500 through upscaling for the created 3D AR object.

The real-time 3D AR object acquisition system 600 according to this embodiment includes an image acquisition device 100 and a 3D AR object acquisition device 200. The image acquisition device 100 acquires a plurality of images required for creating a 3D AR object for the subject 300 in real time. The 3D AR object acquisition device 200 creates the 3D AR object 400 in real time based on the plurality of images, and then acquires the high-resolution 3D AR object 500 through upscaling for the created 3D AR object.

The 3D AR object acquisition device 200 includes a 3D AR object creation module (or a 3D AR object creation processor) 30 and an upscale module (or an upscale processor) 90. The 3D AR object creation module 30 creates the 3D AR object 400 in real time using the plurality of images. The upscale module 90 upscales the resolution of each frame of an image of the created 3D AR object 400 by a factor of n and thereby converts it into the high-resolution 3D AR object 500 in real time. In addition, the 3D AR object acquisition device 200 further includes an interface 10.

Hereinafter, the real-time 3D AR object acquisition system 600 according to this embodiment will be described in detail.

The subject 300 can be a target for making a 3D AR object. For example, the subject 300 may include various targets such as a person, an animal, a thing, a tool, a background, etc. Or, the subject 300 may include at least a part of a shooting environment captured by the image acquisition device 100.

The image acquisition device 100 acquires various types of images necessary for creating a 3D AR object. For example, the image acquisition device 100 may include an RGB camera, a depth camera, a LIDAR sensor, and a radar sensor.

The image acquisition device 100 may be placed at a position where it can capture the subject 300. For example, the RGB camera can capture an RGB image related to the subject 300. The depth camera can capture depth data of the subject 300. The RGB camera and the depth camera are placed so that they can capture the same subject 300, and the shooting distance and shooting angle may be formed equally or similarly within a specified range. The LiDAR sensor can acquire various physical properties such as the distance and shape of the subject 300 by irradiating a laser to the subject 300. In addition, the radar sensor can capture data on the position, speed, direction, etc. of the subject 300 using electromagnetic waves.

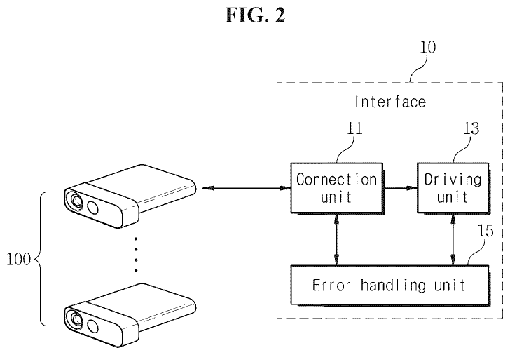

The interface 10, as shown in FIG. 1 and FIG. 2, connects the image acquisition device 100 and the 3D AR object acquisition device 200. Here, FIG. 2 is a diagram showing the interface 10 of the 3D AR object acquisition device 200 of FIG. 1. The interface 10 includes a connection unit 11, a driving unit 13, and an error handling unit 15.

The connection unit 11 supports the connection of the image acquisition device 100 and the 3D AR object creation module 30. The connection unit 11 may include a wired cable inserted into a connector quipped in the image acquisition device 100, and a connection pin or device connector connected to the wired cable. Or, if the image acquisition device 100 is configured to support image transmission through wireless communication, the connection unit 11 may include a wireless communication interface that can form a wireless communication channel with the image acquisition device 100. That is, the connection unit 11 may include a wired communication interface (e.g., connection through a cable) that can be connected to the image acquisition device 100, or a wireless communication interface that can form a wireless communication channel with the image acquisition device 100. If the image acquisition device 100 does not include a separate battery, the connection unit 11 may further include wiring capable of supplying power to the image acquisition device 100.

The driving unit 13 controls the driving of the image acquisition device 100 and checks the connection status of the image acquisition device 100 and the on-off status of the image acquisition device 100. When the image acquisition device 100 is connected through the connection unit 11, the driving unit 13 can collect identification information of the image acquisition device 100 and the type and specification information of each image acquisition device 100 through initial data transmission/reception with the connected image acquisition device 100. The driving unit 13 can execute an application for driving the image acquisition device 100. The driving unit 13 can perform initial settings of the image acquisition device 100 based on predefined settings and adjust the setting values of each image acquisition device 100 in response to a user's manipulation. The driving unit 13 can control the turn-on of the image acquisition device 100 in response to a user's manipulation or the execution of a specific application (e.g., an application supporting a 3D AR object image providing function), and can control the turn-off of the image acquisition device 100 in response to the termination of the application.

The error handling unit 15 provides error information occurring in the physical connection or setting value setup of the image acquisition device 100.

In addition, the interface 10 may further include an output unit such as a display or an audio device that can output information related to the connection of the image acquisition device 100. The error handling unit 15 can output a list of the connected image acquisition devices 100 to the display upon the connection of the image acquisition devices 100, and output the status of each image acquisition device 100 (e.g., initialization completion, setting values of the image acquisition device) to the output unit. In this process, the error handling unit 15 can output identification information and error information about the image acquisition device 100 that is not operating normally among the image acquisition devices 100 to the output unit. The error information may include a problem of the image acquisition device 100 where an error occurred.

In addition, the 3D AR object acquisition device 200 includes, as mentioned above, the 3D AR object creation module 30 and the upscale module 90.

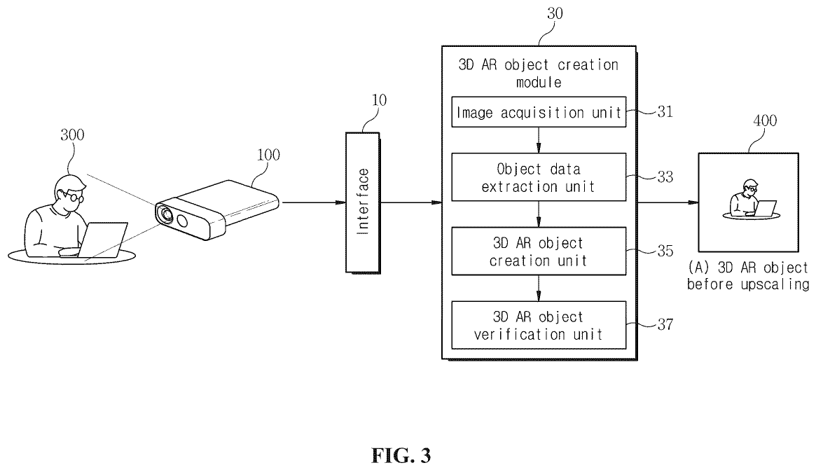

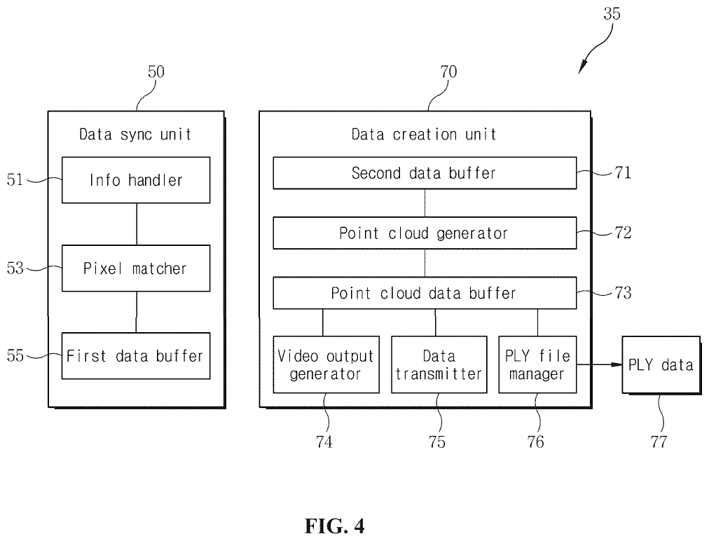

As shown in FIGS. 1 to 4, the 3D AR object creation module 30 includes an image acquisition unit 31, an object data extraction unit (or an object data extraction processor) 33, a 3D AR object creation unit (or a 3D AR object creation processor) 35, and a 3D AR object verification unit (or a 3D AR object verification processor) 37. Here, FIG. 3 is a diagram showing the 3D AR object creation module 30 of the 3D AR object acquisition device 200 of FIG. 1. In addition, FIG. 4 is a diagram showing the 3D AR object creation unit 35 of FIG. 3.

The image acquisition unit 31 receives and acquires images from the image acquisition device 100 according to a user's manipulation or the execution of a specific application. In this process, the image acquisition unit 31 can identify information on the image acquisition device 100 connected and activated through the interface 10 and identify the type of image that can be acquired by the image acquisition device 100. For example, if the image acquisition device 100 does not include cameras capable of respectively acquiring RGB images and depth images, the image acquisition unit 31 can transmit an error message to the error handling unit 15 of the interface 10. The error handling unit 15 that receives the error message can output error information requesting the connection or turn-on of a camera of a type (e.g., an RGB camera or a depth camera) that is not currently connected. When both the RGB camera and the depth camera are connected and the RGB image and the depth image are transmitted normally, the image acquisition unit 31 can transmit the acquired images to the object data extraction unit 33. The RGB image and the depth image received by the object data extraction unit 33 may include an image of the entire shooting environment including the subject 300.

The object data extraction unit 33 extracts data for a specific object selected from each of a plurality of images. The object data extraction unit 33 can perform filtering to acquire only desired data based on the images received from the image acquisition unit 31. For example, the object data extraction unit 33 can filter subjects 300 at a certain depth by utilizing the depth value. The object data extraction unit 33 can separately extract an RGB image for the subject 300 at a certain depth. The object data extraction unit 33 can perform object detection based on a boundary line in the RGB image and selectively filter objects at a certain depth based on the depth information. Or, the object data extraction unit 33 can perform filtering for an object including a specific pattern (e.g., a human face pattern or a specific animal pattern, etc.) in the RGB image based on the depth information for the object. That is, the object data extraction unit 33 can acquire only RGB data and depth data for at least some objects in the subject 300 through filtering.

The 3D AR object creation unit 35 merges the extracted object data to create the 3D AR object 400. The 3D AR object creation unit 35 may include a data sync unit 50 and a data creation unit 70.

The data sync unit 50 may include an info handler 51, a pixel matcher 53, and a first data buffer 55.

The info handler 51 may acquire depth data and RGB data from the data delivered from the object data extraction unit 33. In this process, the info handler 51 may acquire the resolution information of the depth data and the resolution information of the RGB data together from the object data extraction unit 33. Or, the info handler 51 may acquire from the interface 10 the resolution information of the RGB camera that provides the RGB image and the resolution information of the depth camera that provides the depth image.

The pixel matcher 53 can change the resolution of RGB data. That is, for point cloud generation, the pixel matcher 53 can convert the size of RGB information to match depth information when the RGB information (resolution: 1920*1080) and the depth information (resolution: 1024*1024) have different resolutions. The pixel matcher 53 can store the changed information in the first data buffer 55.

The first data buffer 55 can store the RGB data and depth data matched by the pixel matcher 53. Here, the stored RGB data may be information converted to match the resolution of the depth data.

The data creation unit 70 may include a second data buffer 71, a point cloud generator 72, a point cloud data buffer 73, a video output generator 74, a data transmitter 75, and a PLY file manager 76.

The second data buffer 71 can receive the depth data and the RGB data converted based on the depth data by the data sync unit 50 from the first data buffer 55 and temporarily store them. The second data buffer 71 can transfer the stored data (e.g., the RGB data with converted resolution and the depth data) to the point cloud generator 72. At this time, for the point cloud generation, the second data buffer 71 can convert the data received from the first data buffer 55 into a designated data format (e.g., a format defined for the point cloud generation or a format suitable for the purpose of use of the data) and store it.

The point cloud generator 72 can generate point cloud data based on the data stored in the second data buffer 71. For example, the point cloud generator 72 may assign coordinates in 3D space to the data stored in the second data buffer 71 and process a point collection for the assigned coordinates. Here, the point cloud generator 72 may perform an overlay process on the point cloud to build 3D data.

The point cloud data buffer 73 can store point cloud data generated by the point cloud generator 72. The data stored in the point cloud data buffer 73 may include each set of coordinates (or points) corresponding to a 3D AR object image.

The video output generator 74 can generate a video file corresponding to the point cloud data stored in the point cloud data buffer 73 and store the generated video file or transmit it to a designated device. The video generated by the video output generator 74 may include a real-time image of the 3D AR object. In particular, the video file generated by the video output generator 74 may include a real-time video image of the 3D AR object for some objects based on the subject 300.

The data transmitter 75 can transmit the point cloud data stored in the point cloud data buffer 73 to a designated device. For example, when the 3D AR object image support function is performed based on a program such as a video conference or a game, the data transmitter 75 can transmit the point cloud data corresponding to a specific object to another electronic device performing the video conference or the game.

The PLY file manager 76 can generate a 3D polygon file based on the point cloud data. The PLY file manager 76 can define a file format of a polygon corresponding to at least some object of the subject 300 based on the point cloud data. In this process, the PLY file manager 76 can store various properties including color, transparency, surface normal, texture coordinates, and data confidence value of an object corresponding to at least a part of the subject 300. That is, the PLY file manager 76 can perform conversion of PLY data 77 corresponding to the point cloud data.

In addition, the 3D AR object verification unit 37 verifies the created 3D AR object 400. That is, the 3D AR object verification unit 37 verifies the created 3D AR object 400 in order to prepare for error situations such as blank data being created due to an error in the 3D AR object creation unit 35 that creates the 3D AR object 400 or the 3D AR object 400 being created with at least one of the acquired images missing.

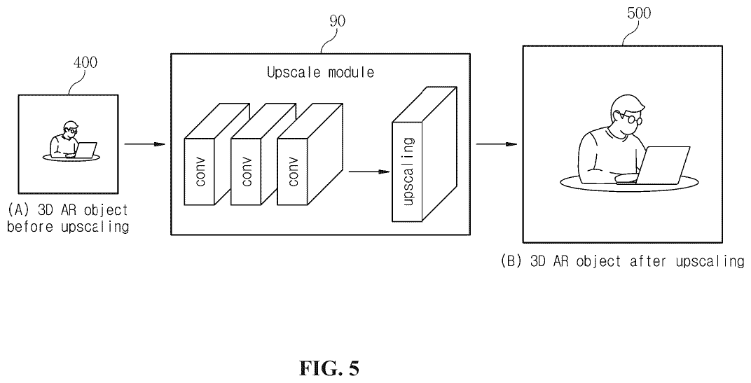

As shown in FIGS. 1 and 5, the upscale module 90 converts the low-resolution 3D AR object 400 created by the 3D AR object creation module 30 into the high-resolution 3D AR object 500 through upscaling. Here, FIG. 5 is a diagram showing the upscale module 90 of the 3D AR object acquisition device of FIG. 1.

The 3D AR object creation module 30 can transmit the image of the created 3D AR object 400 to the upscale module 90 in units of single frame.

The upscale module 90 applies the Super Resolution as an upscaling method. The upscale module 90 can upscale each frame to a real-time processible multiple of the resolution. Preferably, the upscale module 90 upscales each frame to a maximum real-time processible multiple of the resolution.

Here, if the 3D AR object creation module 30 creates an image of the 3D AR object 400, i.e., an image of the 3D AR object 400 before upscaling, in real time, the image quality is relatively poor.

However, through upscaling, the upscale module 39 can improve the image quality of the image of the 3D AR object 400 before upscaling. It can be seen that the image quality of the image of the 3D AR object 500 after upscaling is improved compared to the image of the 3D AR object 400 before upscaling.

As such, according to this embodiment, the 3D AR object acquisition device 200 can provide the high-resolution 3D AR object 500 in real time by creating the 3D AR object 400 in real time using images acquired through the image acquisition device 100 and upscaling the resolution of each frame of an image of the created 3D AR object 400 by a factor of n through the upscale module 90.

### Real-Time 3D AR Object Acquisition Method

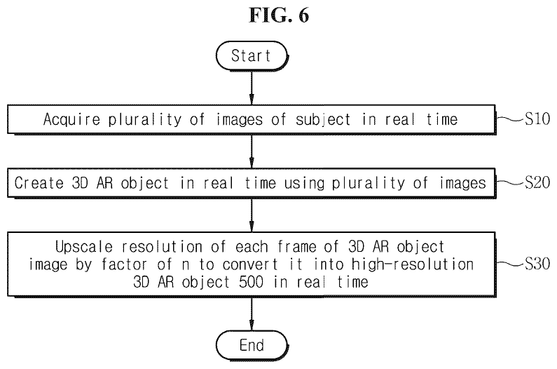

Hereinafter, the real-time 3D AR object acquisition method using the real-time 3D AR object acquisition system 600 according to this embodiment will be described with reference to FIGS. 1 and 6. Here, FIG. 6 is a flowchart showing a real-time 3D AR object acquisition method according to an embodiment of the present disclosure.

First, in step S10, the image acquisition device 100 acquires a plurality of images of the subject 300 in real time, and then transmits the plurality of acquired images to the 3D AR object acquisition device 200 through the interface 10.

Next, in step S20, the 3D AR object acquisition device 200 creates the 3D AR object 400 in real time using the plurality of received images. At this time, an image of the created 3D AR object 400 is an image of the 3D AR object 400 before upscaling.

Then, in step S30, the 3D AR object acquisition device 200 upscales the resolution of each frame of the image of the created 3D AR object 400 by a factor of n to convert it into the high-resolution image of the 3D AR object 500 in real time, thereby acquiring the high-resolution image of the 3D AR object 500 compared to the image of the 3D AR object 400 before upscaling. The image of the 3D AR object 500 acquired at this time is the image of the 3D AR object 500 after upscaling.

While the present disclosure has been particularly shown and described with reference to an exemplary embodiment thereof, it will be understood by those skilled in the art that various changes in form and details may be made therein without departing from the scope of the present disclosure as defined by the appended claims.

What is claimed is:

1. A real-time three-dimensional (3D) augmented reality (AR) object acquisition system comprising:
an image acquisition device configured to acquire a plurality of images used for creating a 3D AR object of a subject in real time; and
a 3D AR object acquisition device configured to acquire a high-resolution 3D AR object in real time based on the plurality of images,
wherein the 3D AR object acquisition device comprises:
a 3D AR object creation module configured to create the 3D AR object in real time by using the plurality of images; and
an upscale module configured to upscale a resolution of each frame of an image of the created 3D AR object by a factor of n to convert the 3D AR object into a high-resolution 3D AR object in real time.

2. The real-time 3D AR object acquisition system of claim 1, wherein the image acquisition device includes an RGB camera, a depth camera, a LIDAR sensor, and a radar sensor.

3. The real-time 3D AR object acquisition system of claim 2, wherein the 3D AR object creation module includes:
an object data extraction processor configured to extract data for a specific object selected from each of the plurality of images;
a 3D AR object creation processor configured to merge the extracted object data to create the 3D AR object; and
a 3D AR object verification processor configured to verify the created 3D AR object.

4. The real-time 3D AR object acquisition system of claim 1, wherein the 3D AR object acquisition device further comprises:
an interface configured to connect the image acquisition device and the 3D AR object acquisition device.

5. The real-time 3D AR object acquisition system of claim 4, wherein the interface is configured to:
support a connection of the image acquisition device and the 3D AR object creation module,
control driving of the image acquisition device,
check a connection status of the image acquisition device and an on-off status of the image acquisition device, and
provide error information occurring in a physical connection or setting value setup of the image acquisition device.

6. The real-time 3D AR object acquisition system of claim 1, wherein the 3D AR object creation module is configured to transmit the image of the created 3D AR object to the upscale module in units of single frame.

7. The real-time 3D AR object acquisition system of claim 6, wherein the upscale module is configured to upscale each frame to a real-time processible multiple of resolution.

8. The real-time 3D AR object acquisition system of claim 6, wherein the upscale module is configured to upscale each frame to a maximum real-time processible multiple of resolution.

9. A real-time three-dimensional (3D) augmented reality (AR) object acquisition device comprising:
a 3D AR object creation processor configured to create a 3D AR object in real time by using a plurality of images received from an image acquisition device that acquires the plurality of images used for creating the 3D AR object of a subject in real time; and
an upscale processor configured to upscale a resolution of each frame of an image of the created 3D AR object by a factor of n to convert the 3D AR object into a high-resolution 3D AR object in real time.

10. The real-time 3D AR object acquisition device of claim 9, further comprising:
an interface configured to connect the image acquisition device and the 3D AR object acquisition device,
wherein the interface is further configured to:
support a connection of the image acquisition device and the 3D AR object creation module,
control driving of the image acquisition device,
check a connection status of the image acquisition device and an on-off status of the image acquisition device, and
provide error information occurring in a physical connection or setting value setup of the image acquisition device.

11. The real-time 3D AR object acquisition device of claim 9, wherein the upscale module is configured to upscale each frame to a real-time processible multiple of resolution.

12. A real-time three-dimensional (3D) augmented reality (AR) object acquisition method comprising:
by a real-time 3D AR object acquisition device, receiving a plurality of images from an image acquisition device that acquires the plurality of images used for creating a 3D AR object of a subject in real time;
by the real-time 3D AR object acquisition device, creating the 3D AR object in real time by using the plurality of images; and
by the real-time 3D AR object acquisition device, converting the 3D AR object into a high-resolution 3D AR object in real time by upscaling a resolution of each frame of an image of the created 3D AR object by a factor of n.

13. The real-time 3D AR object acquisition method of claim 12, wherein the converting includes, by the real-time 3D AR object acquisition device, upscaling each frame to a real-time processible multiple of resolution.
